(19) United States
(12) Patent Application Publication
(10) Pub. No.: US 2018/0020648 A1
(43) Pub. Date: Jan. 25, 2018

(54) Counter-cone sleeve for tube fly rigging

(71) Applicant: Juhani Repo, Oulu (FI)

(72) Inventor: Juhani Repo, Oulu (FI)

(21) Appl. No.: 15/654,722

(22) Filed: Jul. 20, 2017

Related U.S. Application Data
(60) Provisional application No. 62/365,407, filed on Jul. 22, 2016.

(51) Int. Cl. A01K 85/08; A01K 85/00

(52) U.S. Cl. CPC A01K 85/08; A01K 85/005

(57) ABSTRACT

The invention presents a solution that makes the rigging of a tube fly, which can be used for fishing with fishing rod arrangements or fishing line, easier and simpler. Using the invention with tube fly rigging helps to make tidier and more symmetrical flies and speeds up the tube fly rigging and serial production. An example of a counter-cone sleeve for tube fly rigging as described herein can include, for example, a sleeve having a counter-cone shape including a front cone section, a mid-section and a rear cone section, wherein there is an angle between an outer surface of the mid-section and an outer surface of the rear cone section of between 95 to 140 degrees and wherein there is an angle between the outer surface of the mid-section and an outer surface of the front cone section of between 95 to 155 degrees, and a hole arranged to penetrate through the counter-cone sleeve, wherein the hole is fitted for a base tube of a tube fly.

### BACKGROUND

The background for the invention has been the technique for tube fly rigging where in the starting phase of the wing rigging a groove or a hollow is made on a front end of a tube of a tube fly with two knotting thread piles and rigging material (hairs) that will become a wing of the tube fly are set on that a groove or a hollow.

When the hairs have been set on the groove or the hollow and they are bound or stretched with a knotting thread, the hairs are raised more than in the flies that are rigged without the groove or the hollow. The groove or the hollow has mainly pre-vented the hair from sliding from under the knotting thread. The sliding and escaping of the hairs on the frame tube is a common problem when rigging tube flies.

This above mentioned operation that reduces rigging problems is in practice laborious, time-consuming and causes variance in the tube flies. However, when used, the tube flies will become better looking and more functional.

Previously there has been no solution that will remove or reduce the problems mentioned previously. Or such a solution that at the same time would make the rigging the tube fly easier, make the tube fly more sinkable and fulfil preconditions for commercial production of the tube flies.

### SUMMARY OF THE INVENTION

The invention is a solution that makes the rigging of a tube fly that is used for fishing with fishing rod arrangements or fishing line easier and simpler.

Using the invention with the tube fly rigging helps to make tidier and more symmetrical flies and speeds up the tube fly rigging and serial production.

With the selection of the production material (properties of plastics or metals or other material) the sinking speed (faster or slower sinking) of a tube fly that is rigged on a counter-cone sleeve can be influenced.

An example of a counter-cone sleeve for tube fly rigging comprises a sleeve having a counter-cone shape including a front cone section, a mid-section and a rear cone section, wherein there is an angle between an outer surface of the mid-section and an outer surface of the rear cone section of between 95 to 140 degrees and wherein there is an angle between the outer surface of the mid-section and an outer surface of the front cone section of between 95 to 155 degrees, and a hole arranged to penetrate through the counter-cone sleeve, wherein the hole is fitted for a base tube of a tube fly.

According to certain examples, some or all of the following may apply. The largest diameter of the front cone section may be smaller than the largest diameter of the rear cone section. The front cone section and rear cone section may be separate and opposing, and wherein between the separate opposing cone surfaces can be a surface arranged for placing wing materials of a tube fly. The counter-cone sleeve may include a rear surface, and wherein the hole penetrating the counter-cone sleeve has a bevel surrounding a hole on the rear surface. There may also be a rounded fold on a terminal end of the rear cone surface, said rounded fold capable of preventing bending of knotting material to an angle during usage or storage of a tube fly.

### DESCRIPTIONS OF THE FIGURES

In the following, the invention is described in detail. The description refers to the accompanying drawings, in which

FIG. 1 shows an example of a counter-cone sleeve according to the invention viewed in profile,

FIG. 2 shows an example of a counter-cone sleeve according to the invention viewed from the front, and

FIG. 3 shows an example of a counter-cone sleeve according to the invention viewed from behind.

### DETAILED DESCRIPTIONS OF EXEMPLARY EMBODIMENTS

The invention relates to a counter-cone sleeve for rigging tube flies. Using it with tube fly rigging makes tube fly rigging easier when plastic or metal tube is used as the body material of a fly.

A tube fly is used as a lure for fishing when a rod fishing arrangement or a hand fishing line is used.

A tube fly is a commonly known fly type in sport fishing and there are several different tube fly designs. When rigging a tube fly many different materials, for example hair, yarn and feather materials, are used. They are attached to a tube body with a knotting thread. A typical and commonly recognizable feature for a tube fly is a tubelike body which can be covered by yarn material or hair selected by a rigger. Commonly a knotting spot (the so called head) of a wing of tube fly is situated at the front part of a tube fly.

A tube fly is attached to a fishing line by threading the line from the front side of the fly through the tube. To the free end of the fishing line which comes through the tube a hook that is used for fishing is knotted. The hook is pulled to the tube or inside it by pulling the fishing line from the front side of the tube. A tube fly therefore does not necessarily include a fixedly attached hook. The attachment methods of a hook for a tube fly are commonly known.

There are many different alternatives for rigging a tube fly. However, the purposes of these are mainly to make a tube fly heavier using a metal body piece.

There exist also so called ‘Conehead’—heads, which are used as additional weights that are placed on a binding spot on a front part of a tube fly. The swimming of a tube fly may be animated also by some other effect arrangements that are to be placed on a binding spot. These arrangements are often costly and complicated to use and do not necessary even provide the desired effect for the fly.

The most common way to manufacture a tube fly is to rig it to a short plastic tube cut from a cotton swab or similar having a small outer diameter without additional weights or other effect arrangements. To rig a tube fly on a mere straight tube demands quite lot of practice in order to produce a durable and more prestigious rigging. All fly riggers also know that binding the head of a fly cleanly is not always easy.

The counter-cone sleeve can be designed to be used on a connection point of wing materials of a tube fly as a base and a support member when a plastic or a metal tube is used as a base tube.

Using a counter-cone sleeve according to the invention in the tube fly rigging diminishes the neatness problem of the head of the fly and creates the right posture for the wing of the tube fly by lifting the material upwards.

Usually when rigging a tube fly, it is common that materials set on the head of the fly will escape forward from the knotting spot and therefore they do not stay fixed in a planned attachment spot.

When a counter-cone sleeve in used in the tube fly rigging the aforementioned problem will significantly diminish or is totally removed. In that case the forward sliding of the hairs is prevented by a raised conelike threshold of a leading edge of the counter-cone sleeve. However, the functionality of this feature is in part the responsibility of a fly rigger and it depends on the amount of the material used in rigging. Not too much material should be used or the properties of the counter-cone sleeve will deteriorate.

When a counter-cone sleeve has been used when making a base for a big wing of a tube fly and binding and attaching the wing on a base tube, the excess hairs on the front side of the base tube are easy to clean away, because they are cuttable right along the leading edge of the counter-cone sleeve. This promotes significantly achieving a neat result. A counter-cone sleeve can be used also for an additional wing on the rear part of the tube fly similarly as was described before.

The counter-cone sleeve and the base tube of the tube fly are also possible to re-use if only the hairs of the tube fly are damaged and the sleeve itself is intact. Old hairs can be removed carefully from the sleeve by cutting them and new wing materials can be attached over the old counter-cone sleeve. This operation was not possible earlier.

A counter-cone sleeve can be provided for tube fly rigging. There can be a hole that is arranged to penetrate through the counter-cone sleeve and the hole can be fitted for a base tube of the tube fly. On an outer surface of the counter-cone sleeve there can be two separate opposing cone surfaces, a front cone surface and a rear cone surface and angle between the outer surface and the rear cone surface can be 95 to 140 degrees. An angle between the outer surface and the front cone surface can also be 95 to 155 degrees.

According to certain examples, the outer diameter of the front cone can be smaller than the outer diameter of the rear cone.

A counter-cone sleeve may also comprise a surface for placing wing materials of the tube fly. Such a surface can be on the sleeve between the separate opposing cone surfaces.

There may also be a rear surface and a hole penetrating the counter-cone sleeve can have a bevel surrounding the hole on the rear surface.

A counter-cone sleeve may be manufactured from plastic, metal, carbon fiber, composite or some compressible material. The surface of the countercone sleeve can be colored and/or the color of the surface of the counter-cone sleeve can be the color of the manufacturing material.

The embodiments in the following description are given as examples only and someone skilled in the art can carry out the basic idea of the invention also in some other way than what is described in the description. Though the description may refer to a certain embodiment or embodiments in several places, this does not mean that the reference would be directed towards only one described embodiment or that the described characteristic would be usable only in one de-scribed embodiment. The individual characteristics of two or more embodiments may be combined and new embodiments of the invention may thus be provided.

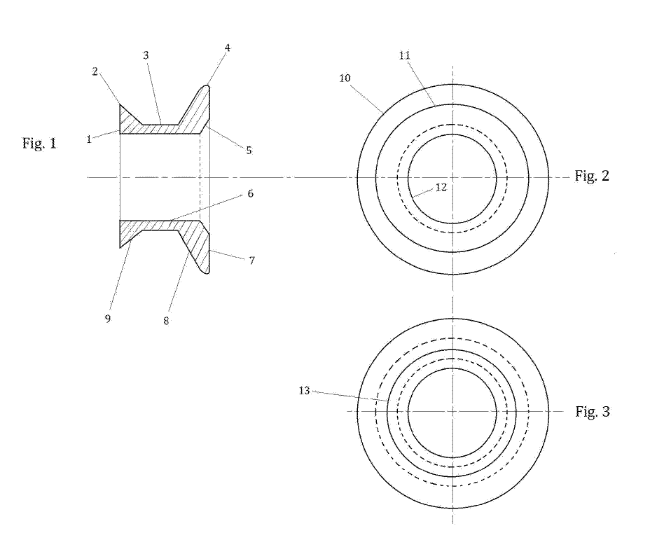

In FIGS. 1 to 3 is disclosed an example of the invention. It is a counter-cone sleeve comprising one solid piece that is manufactured injection molded plastic mixture. Other methods can be used too, such as printing with a 3D printer, using laser sintering or compressing some compressible material. The counter-cone sleeve could also be manufactured from different metals or composites by casting, turning or rolling. The sleeve comprises the characteristic features that are a straight front surface 1, and a front cone 2 that prevent the materials knotted onto the sleeve escaping forwards. In FIG. 1 is disclosed a surface 3 between opposing cone surfaces where knotting materials are placed and they are tied and stretched by a knotting thread.

In FIG. 1 is disclosed a rear cone surface 8 that is at an angle of 95 to 140 degrees in relation to the surface 3. Due to the rear cone surface 8 wing materials of a tube fly are rising upwards from the body of the tube fly. The rear cone surface 8 has a fold 4. The fold 4 is rounded. The purpose of this is to prevent bending of the knotting materials to an angle during the use or stowage of the tube fly. The counter-cone sleeve has a straight rear surface 7. The counter-cone sleeve has a straight hole 6 that goes through the countercone sleeve and the size of the hole is arranged according to size of a base tube. At the rear end of the hole is a bevel 5. The bevel surrounds the hole on the rear surface 7. The bevel goes on the base material of the tube fly. The bevel boosts the locking of the base material.

In FIG. 1 is disclosed a front cone surface 9 that prevents the knotting materials escaping forwards. The front cone surface opens at an angle of 95 to 155 degrees in relation to the surface 3.

The mid-portion of the counter-cone sleeve labeled surface 3 can be generally cylindrical, as shown in FIG. 1. The generally cylindrical mid-section can have a constant diameter, as shown, between the front cone 2 and rear cone surface 8. The mid-section may also have other geometries such as a concave or convex bow in the center or have a front to back increasing or decreasing diameter, for instance. The disclosure herein typically references a constant diameter mid-section and therefore the angles are with regards the intersection between the two indicated surfaces. In examples where the mid-section is not of constant diameter, then the angles can be considered with regards to an imaginary plane extending between A) the intersection of the front cone surface 9 and surface 3 of the mid-section, and B) the intersection of the surface 3 of the mid-section and the rear cone surface 8.

In FIG. 2 is disclosed the fold 10 of the rear cone of the counter-cone sleeve. The rear cone fold is circular. The front cone has a front cone fold 11 that is circular. The hole 12 is cylindrical and goes through the counter-cone sleeve. The shape of the hole is circular and its inner diameter is arranged according to the used base tube.

In FIG. 3 is disclosed the bevel 13. The bevel is around the hole on the rear surface of the counter-cone sleeve and it is circular. The shaping of the bevel boosts the locking of the base material.

The invention is described above in detail. However, the invention does not limit only the shapes and contours that are given in the FIGS. 1 to 3. Some variable factors of a counter-cone sleeve could be for example a diameter of a sleeve penetrating hole, a depth and angle of a bevel on a rear surface and outer diameters of cones. Also folds and angles of the cones are variable.

Some advantageous embodiments of the method and device according to the invention have been described above. The invention is however not limited to the embodiments described above, but the inventive idea can be applied in numerous ways within the scope of the claims.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A counter-cone sleeve for tube fly rigging comprising;
a sleeve having a counter-cone shape including a front cone section, a mid-section and a rear cone section, wherein there is an angle between an outer surface of the mid-section and an outer surface of the rear cone section of between 95 to 140 degrees and wherein there is an angle between the outer surface of the mid-section and an outer surface of the front cone section of between 95 to 155 degrees, and
a hole arranged to penetrate through the counter-cone sleeve, wherein the hole is fitted for a base tube of a tube fly.

2. The counter-cone sleeve according to claim 1, wherein largest diameter of the front cone section is smaller than the largest diameter of the rear cone section.

3. The counter-cone sleeve according to claim 1, wherein the front cone section and rear cone section are separate and opposing, and wherein between the separate opposing cone surfaces is a surface arranged for placing wing materials of a tube fly.

4. The counter-cone sleeve according to claim 1, wherein the counter-cone sleeve includes a rear surface, and wherein the hole penetrating the counter-cone sleeve has a bevel surrounding a hole on the rear surface.

5. The counter-cone sleeve according to claim 1, wherein the counter-cone sleeve is manufactured plastic, metal, carbon fiber or composite and the surface of the counter-cone sleeve is colored or the color of the surface of the counter-cone sleeve is the color of the manufacturing material.

6. The counter-cone sleeve according to claim 1, further comprising a rounded fold on a terminal end of the rear cone surface, said rounded fold capable of preventing bending of knotting material to an angle during usage or storage of a tube fly.
